(19) United States
(12) Patent Application Publication
(10) Pub. No.: US 2012/0062872 A1
(43) Pub. Date: Mar. 15, 2012

(54) Mesh Sensor for Measuring Directed Energy

(76) Inventors: Derek Strembicke, Huntsville, AL (US); Jay Lewis, Research Triangel Park, NC (US); Milan Bunick, Huntsville, AL (US); James Luke, Huntsville, AL (US); David Thomas, Huntsville, AL (US)

(21) Appl. No.: 12/570,996

(22) Filed: Sep. 30, 2009

Related U.S. Application Data
(63) Continuation of application No. 12/405,998, filed on Mar. 17, 2009, now abandoned.
(60) Provisional application No. 61/037,206, filed on Mar. 17, 2008.

(51) Int. Cl. G01N 21/00

(52) U.S. Cl. 356/72

(57) ABSTRACT

A mesh sensor system for measuring the performance of directed energy weapons at a target has been developed. The mesh sensor system measures the laser irradiance and the thermal response on the target. The system includes a plurality of sensors arranged on the target surface and a plurality connecting lines that connect with the sensors to provide power and retrieve data from the sensors.

### CROSS-REFERENCE TO RELATED APPLICATIONS

This application is a continuation application of U.S. patent application Ser. No. 12/405,998 entitled “Mesh Sensor for Measuring Directed Energy” that was filed on Mar. 17, 2009 which claims priority from U.S. Provisional Patent Application No. 61/037,206 entitled “Mesh Sensor for Measuring Directed Energy” that was filed on Mar. 17, 2008.

### FIELD OF THE INVENTION

The invention relates generally to sensors for monitoring direct energy devices.

More specifically, the invention relates to a mesh sensor that monitors the effects of direct energy weapon systems on various targets.

### BACKGROUND ART

Directed Energy (DE) weapon systems show tremendous promise to completely redefine the battlefield. From high-power microwave (HPM) systems such as the Active Denial System (ADS) to high energy laser (HEL) systems such as the Airborne Laser (ABL) or the Tactical High Energy Laser (THEL), these weapons systems have capabilities that are truly revolutionary. Benefits of these systems include: (1) rapid engagement of multiple targets; (2) surgical precision; (3) deep magazines; and (4) reduced cost per shot.

High energy lasers in particular show great promise to be able to provide a protective countermeasure for both ballistic and tactical missiles, mortars and artillery shells. Advances in high power laser sources are showing the potential to make these systems smaller, more mobile, consume lower power, easier to protect and safer to operate.

Advancements in DE weapon systems are outpacing the technologies needed for test and evaluation (T&E). Current DE T&E capabilities are insufficient to support the developmental, operational, and live fire testing requirements of DE acquisition programs. Because DE weapons systems are relatively new, the required legacy and infrastructure for DE T&E has not been created. Development of many of the infrastructure items required to test DE weapons will require advancement and maturation of various existing and emerging technologies. One of the current DE programs is the development of HEL systems to target and destroy missiles in flight. For T&E of HEL systems, there is a requirement to make high-spatial resolution measurements of a laser spot incident on HEL targets by appending an externally mounted sensor package onto the missile.

There are currently no technologies available to directly measure either the incident laser irradiance or the thermal response of ballistic missile target. Consequently, there is a need for the sensor that offers the potential for a low cost system that can provide near real-time data on laser radiation interaction with a missile surface.

### SUMMARY OF THE INVENTION

In some aspects, the invention relates to a temperature and irradiance sensor matrix located on a test ballistic missile target, comprising: multiple sensors arranged in a grid pattern that exposes 90% of the underlying surface of the target, where the individual sensors comprise, a sensor layer that further comprises, a substrate, separate conductive electrodes for receiving power and collecting data, a dielectric insulating layer for insulating the separate electrodes, a photoconductive detector for detecting laser irradiation, and a resistive temperature detector for measuring the surface temperature of the target, and a protective coating layer that overlays the sensor layer that comprises a metal layer that is 2 microns in thickness with has an aperture that is 150 microns in diameter that allows the laser irradiation to reach the sensor layer; connection lines that provide power to the sensors and retrieve data from the sensors; and an onboard computer that collects data from the sensors and transmits the data to a ground station via radio telemetry.

In other aspects, the invention relates to an apparatus for measuring laser irradiance and thermal response on a target, comprising: a plurality of sensors arranged on the target surface; and a plurality connecting lines that connect with the sensors to provide power and retrieve data from the sensor.

In other aspects, the invention relates to an apparatus for measuring laser irradiance and thermal response on a target, comprising: means for detecting laser irradiation on the skin of the target with a photoconductive detector; means for measuring the surface temperature of the target with a resistive temperature detector; and means for collecting and transmitting data concerning the laser irradiation and surface temperature to a receiving station.

Other aspects and advantages of the invention will be apparent from the following description and the appended claims.

### BRIEF DESCRIPTION OF DRAWINGS

It should be noted that identical features in different drawings are shown with the same reference numeral.

FIG. 1 shows a diagram of a high energy laser (HEL) impacting a Temperature and Irradiance Sensor Matrix (TISM) in accordance with one embodiment of the present invention.

FIGS. 2a and 2b show a diagram of the components of a Temperature and

Irradiance Sensor Matrix (TISM) in accordance with one embodiment of the present invention.

FIGS. 3a-3c show different views of a Temperature and Irradiance Sensor Matrix (TISM) appended to a target missile in accordance with one embodiment of the present invention.

### DETAILED DESCRIPTION

The present invention is an on-board sensor for directed energy (DE) diagnostics. The sensor, called a Temperature and Irradiance Sensor Matrix (TISM), is located in the beam path to allow direct measurement of relevant parameters. The sensor provides a solution so that both incident laser irradiance and the thermal response of the target body can be directly measured in real time. One embodiment of the present invention is an appended conformal sensor array that relays the data to a ground terminal. A conformal sensor array will minimize aerodynamic effects, and if the sensor array is designed properly, can have minimal optical and/or thermal interactions with the tracking and laser systems. In addition, a sensor array fabricated by standard lithography, dry-film lithography (collectively referred to as lithography), a nanoparticle printing process, or a hybrid combination of lithography and printing would be easily adaptable and reconfigurable, and could be produced at low cost. The materials for fabrication of these sensor arrays are produced commercially and are readily available.

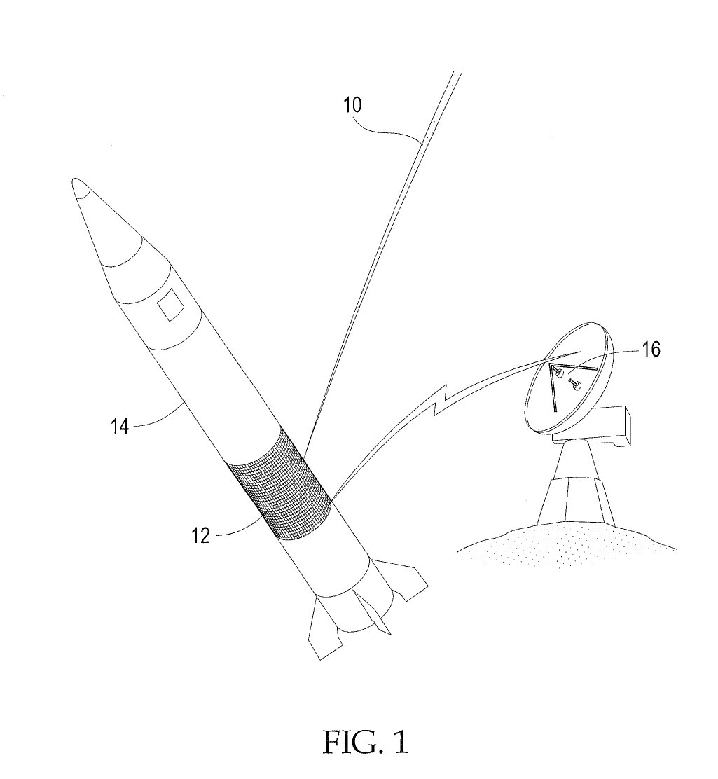

FIG. 1 shows a diagram of a high energy laser (HEL) 10 impacting a

Temperature and Irradiance Sensor Matrix (TISM) 12. The TISM sensor array 12 system capable of detecting a laser spot incident on a missile target 14 that is suitable for sensing laser target designators and HEL weapons. The sensor system provides spatial illumination and temperature rise data and communicates those data via telemetry 16 in real time. In addition to tracking HEL irradiation of a ballistic missile, the development of the sensor array, the TISM has capabilities for other applications where large-area, light-weight, conformal sensors are needed. The TISM is also a robust system that can withstand environmental conditions during storage, deployment, and flight.

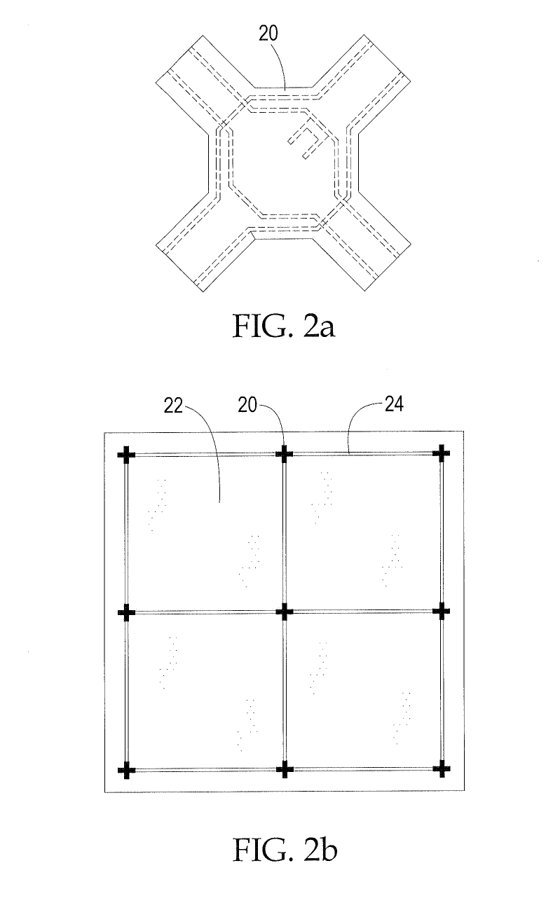

FIGS. 2a and 2b show a diagram of the components of a Temperature and Irradiance Sensor Matrix (TISM). FIG. 2a shows a detail view of a photodetector 20. FIG. 2b shows a detail view a sensor matrix 22. The TISM 22 is comprised of small photodetector sensor nodes 20 that are arrayed to cover a larger area. In a first design, the nodes 20 are comprised of two layers: an underlying sensor layer and a second layer that is the protective coating. The protective coating may consist of two different layers that are laminated together to form the final structure, or the protective layer may be a partially transmissive coating applied to the sensor layer, resulting in a single layer device.

The first sensor layer is built up using numerous materials, including the substrate, conductive electrodes, dielectric insulating layers, the irradiance sensor, and the temperature sensor. The substrate is conformal, and may be made of copper, stainless steel, Kovar or other sheet material that is conformal and can be processed using lithography or the nanoparticle printing process. Electrodes, dielectric layers and sensors are printed onto the substrate using a nanoparticle printing process, much like an inkjet printer. Electrodes are made from conductive materials, like silver (Ag), gold (Au) or nickel (Ni). The dielectric layer provides electrical insulation between overlapping electrode layers to prevent shorting. The temperature sensor is made from metals or oxide materials for HEL applications, although polymeric or other materials can also be used for different applications. The irradiance sensor is also deposited onto the substrate, and can be made from lead sulfide (PbS) quantum dots (QDs).

The individual nodes of the sensor mesh 20 contain a photoconductive detector

(PCD) to detect laser irradiation, and resistive temperature detector (RTD) to directly measure surface temperature. These devices are fabricated from air-stable materials, can tolerate high temperatures, and can be fabricated on large area substrates by lithography or printing. To minimize the effect of the array on the thermal and optical interactions of the laser with the missile surface, the array will be fabricated using an open mesh architecture exposing up to 90% of the missile surface to the environment.

The sensor matrix 22 will achieve 1 cm resolution, be up to 90% open, have an irradiance sensor capable of measuring the laser wavelengths of interest (1.0-2.0 μm) resulting in less than 5% interaction with the incident beam and minimal effect on thermal behavior of the target. The matrix adheres to the missile surface in a conformal manner so as to have minimal effect on missile aerodynamics, be lightweight, and withstand temperatures of over 600° C. Sensor readout electronics will be connected to the end of the sense matrix and attached to the missile body within an aerodynamic enclosure. Appropriate signal conditioning electronics will encode and wirelessly transmit the data to a ground receiver using current telemetry standards.

FIG. 2b depicts how a TISM 22 can be formed from individual sensor nodes 20.

Each node 20 is joined by intersecting lines 24. The lines 24 are made of a substrate and protective coating layers that are laminated together, much like the node structure. A pair of electrodes is printed onto the substrate layer and provides addressability and power for the sensors.

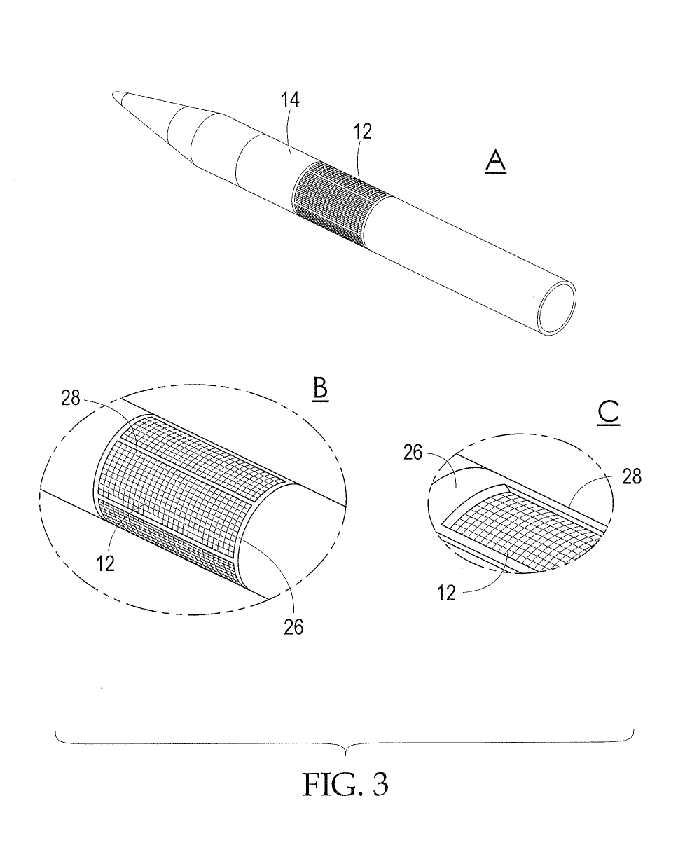

FIGS. 3a-3c show different views of a Temperature and Irradiance Sensor Matrix (TISM) appended to a target missile. The Figure show ribs 26 and spines 28 that are additional features for a TISM 12 in an alternative embodiment. The circumferential ribs 26 provide a covering for readout electronics, power supply and RF telemetry. The linear spines 28 will house bundles of power and readout electrodes and are shown as being larger than sensor nodes. However, they may in fact only be rows of electrodes in the final design.

It is also possible to configure the TISM dimensions that considers the benefits of addressing as many individual sensor nodes as possible versus the spatial area required for readout and power electrodes for each node individually. Ideally each node will be individually operational, so that if one node is damaged in test, surrounding nodes that survive are still operational. To accomplish this, the TISM 12 can be divided into sections that are separated by spines 28. The spines 28 will contain bundles of power and readout electrodes that can address many nodes individually. For aerodynamic modeling purposes, the notional ribs 26 and spines 28 may have a maximum height above the missile body of ˜40 mm and the TISM sensor structure may have a height of ˜2 mm above the missile.

In order for the sensor to survive the rapid heating that occurs for materials experiencing direct exposure to a high energy laser (HEL) laser beam, the sensors must be protected. The protective layer must be relatively thin. To be robust, the protective layer must reflect light energy, conduct heat away from the region exposed to the laser, or both.

One type of protective layer is a metal sheet that is coated with a thin layer of gold. The gold provides excellent reflectivity for laser wavelengths of interest. Both gold and copper have excellent thermal conductivity, and can rapidly dissipate heat away from the region being exposed to the laser. The copper sheet can be 5 mil (127 microns). The thin layer may be 2 microns thick and can be deposited using e-beam deposition, sputtering or plating processes. The copper sheet may be pre-processed prior to deposition of the gold to enhance surface properties for better performance.

The protective layer should be able to provide controlled transmission of a portion of the beam to the irradiance sensor. There are a number of ways to provide controlled transmission through a hardened material. One method involves creating a small hole (aperture) in the protective coating. The aperture may be 150 micron in diameter. An air channel should be provided so that light entering the aperture can propagate from the aperture to the irradiance sensor. The air channel can be fabricated by several methods, including chemical etch or partial lithographic etch. The aperture may be fabricated in the metal foil prior to deposition of gold so that the sides of the hole are also covered. It may also be possible to plate gold directly onto the sensor layer. In this case, the air gap might be created by first patterning the gap region with a sacrificial material that can be removed after the gold is deposited.

Another method for providing controlled transmission of a portion of the beam to the irradiance sensor involves fabricating a thin metal layer (e.g., Au) that is partially transmissive. The irradiance sensor is positioned behind the gold so that it can detect the portion of the light that is transmitted through the protective coating. For example, 400 nm of Au will provide 99.9% reflectivity, and ˜0.1% transmission. Test data shows that this thickness of gold is sufficient to protect the sensor to irradiance levels around 1.5 kW/cm² for 10 seconds.

It is also possible to use woven ceramic fibers in a sheet. Ceramics can be highly reflective in the wavelengths of interest, and have good thermal stability. Tests have shown that ceramic sheets can survive irradiance levels of 1.5 kW/cm² for 10 seconds. However, the amount of light passing through the ceramic should be controlled.

Since the copper or gold-coated copper protective coating is very thin, it is possible to assemble multiple layers to enhance survivability. For example, two or three coated foils can be adhered or pressed together to extend the lifetime of the underlying sensor layer. Tests have shown that multiple layers have a longer lifetime than single layers.

There are several interfaces between constituent materials that may require adhesion or lamination. In some cases, individual materials need to be adhered to the substrate, or to other sensor materials. In one design, there are two layers that must be adhered to each other. For material-to-material adhesion, standard adhesion promoters may be used (e.g., chrome or titanium). Other materials may be used for inter-layer adhesion (e.g., a molecular layer that bonds to both surfaces). For lamination of the two layers that make up the TISM structure (i.e., sensor layer and protective coating), there are a number of different methods that might be used, including: electrodeless plating; adhesion with high temperature adhesives; adhesion using exothermic nanofoils; adhesion using nanoparticles; and welding using very small beads or spots.

In addition to the sparse mesh concept where the structure is open so that a portion of the target is exposed to the laser, other designs can be developed for additional applications. For example, it is possible to develop a dense mesh of irradiance sensors with higher spatial resolution. In this case, the sensor tiles would be solid, with solid protective coating. Apertures would be fabricated in the protective coating and laminated in such a way that the holes were aligned properly over the underlying sensor tile. This design offers superior lifetime capabilities. The solid protective layer (as opposed to an open mesh architecture) provides more surface area that can be used to conduct heat away from the sensors, thereby extending the lifetime of the array. Additionally, the sensor layer can be attached to a mass that acts as a heat sink, allowing the sensors to be cooled. The term used for this device is the Cooled PCD Array. This device would be useful in tests where the mass of the sensor is not an issue, for example in laboratory, test range and target board applications.

In another embodiment, it is possible to create a dense mesh of irradiance sensors that does not require a protective coating. The application would necessarily involve lower irradiance levels to allow the sensor to survive. The sensors may be coated with a transparent or partially transmissive coating that serves to protect the sensors from mechanical damage. One such application is the determination of the accuracy and stability of an aimpoint or tracking laser on a target. In this application, an aimpoint sensor matrix would be attached to a target and would record spatial and temporal irradiance data while illuminated by the aimpoint or tracking laser.

In another embodiment, it is possible to create a dense array of temperature sensors that provide high spatial resolution of thermal data. In applications where the sensor array will be exposed to the laser beam, a protective coating will be required. This device may be simpler to build since the protective coating does not need to have an aperture. It may be possible to further simplify the fabrication process by depositing the protective coating directly onto the sensor layer. This approach would eliminate the need for a second layer and the required lamination process. It is possible to build a temperature sensor array that does not need coating, for example when the sensor array will be positioned outside of the beam and therefore not be exposed directly to high irradiance levels. Sensors can be placed outside the periphery of the laser beam, and inverse heat conduction (IHC) equations used to calculate the temperature within the region exposed to the laser. It may be possible to develop a sensor array with a central region removed. In this arrangement, the sensor can be placed over a sample, and the laser aligned with the center of the hole. During a test, the sensors would acquire data without experiencing direct exposure to the beam. In another design, a sheet of sensors could be wrapped around a cylindrical target, but placed on either side of the region exposed to laser. Data collected from the sensor array could be fed into direct IHC equations to provide temperature information.

One application of the high resolution temperature array involves positioning the sensor on the back side of a target and acquiring the thermal response of the target to laser heating. In this setup, the laser is incident on the front side of the target. The data collected by the temperature array can be fed into a physics-based software model that calculates the conduction of heat through the sample in the inverse direction. This software is termed the Inverse Heat Conduction (IHC) model. The IHC model can be used to predict the heating by the laser on the front surface. The system that combines sensors and physics model is termed the Inversion-derived Resistive Temperature Sensor (IRTS).

In another embodiment, irradiance sensor nodes can be laminated onto a hemispherical dome and positioned over a target so that the reflectance from the target is recorded, regardless of deflected angle. It may also be helpful to co-locate temperature sensors with the irradiance sensors to collect additional information.

It is possible to package the irradiance and/or temperature sensors inside an enclosure that protects the sensors and electronics from harsh conditions, for example in maritime environments. In this application, the sensor array would be positioned behind a highly transparent window that allowed laser light to penetrate while protecting the sensor from sea spray, salt and other degrading conditions. The sensor array, readout electronics, power supply and data recorder/telemetry system would be enclosed in a rugged case. It may be possible to position the ruggedized sensor on a buoy and deployed at sea. It may be possible to develop a spherical sensor head that is insensitive to rotation so that the motion of the buoy does not affect sensor accuracy. The sensor would detect incident irradiance and/or corresponding temperature rise regardless of orientation. It may also be possible to use an integrating sphere or similar design to realize the same objective.

In many of the applications listed above, it may be desirable to develop a convenient mechanism for coupling the sensor mesh to a data acquisition system. The coupling mechanism would allow the re-use of data acquisition hardware. If sensors are damaged or destroyed during test then a new sensor could be placed in the test setup. This concept is particularly useful in the IRTS concept, where the data acquisition system is tied to a physics-based model.

There are several techniques for providing readout electronics that convert the information obtained by the sensor to a signal that can be digitized on a computer. One method is termed a line scan, and is analogous to the method of readout used by commercial CMOS imaging systems. Regardless of the method of readout, the data can be sent stored on-board for later retrieval (black box method) or sent to an off-board computer using telemetry. In the case of a laboratory sensor, or towed target board, it is possible to cable directly from the sensor mesh to a data acquisition computer located on the tow plane (or UAV) or elsewhere in the laboratory or test setup.

It should be clear from the preceding description and accompanying figures that the present invention is a mesh sensor for measuring directed energy that has the following features: microsensors that measure both optical irradiance and target thermal reaction; externally-mounted microsensors that have minimal effect on aerodynamic and thermal signature for targets in flight; a mesh network of microsensors that is capable of surviving under peak irradiances of several kW/cm², aerodynamic shear forces, and thermal effects of an in-flight missile; a mesh network of microsensors that transmits data to ground station via RF telemetry; a mesh network of microsensors that exposes 90% of target surface area is exposed to the laser and has a total thickness of ˜0.2 mm; and a mesh network of microsensors that is made of a conformal array with a flexible substrate.

While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

What is claimed is:

1. A temperature and irradiance sensor matrix located on a test ballistic missile target, comprising:
(1.) multiple sensors arranged in a grid pattern that exposes 90% of the underlying surface of the target, where the individual sensors comprise,
a.) a sensor layer that further comprises,
i.) a substrate,
ii.) separate conductive electrodes for receiving power and collecting data,
iii.) a dielectric insulating layer for insulating the separate electrodes,
iv.) a photoconductive detector for detecting laser irradiation, and
v.) a resistive temperature detector for measuring the surface temperature of the target, and
b.) a protective coating layer that overlays the sensor layer that comprises a metal layer that is 2 microns in thickness with has an aperture that is 150 microns in diameter that allows the laser irradiation to reach the sensor layer;
(2.) connection lines that provide power to the sensors and retrieve data from the sensors; and
(3.) an onboard computer that collects data from the sensors and transmits the data to a ground station via radio telemetry.

2. An apparatus for measuring laser irradiance and thermal response on a target, comprising:
a plurality of sensors arranged on the target surface; and
a plurality connecting lines that connect with the sensors to provide power and retrieve data from the sensors.

3. The apparatus of claim 2, where the sensors are arranged in a grid pattern that exposes 90% of the underlying surface of the target.

4. The apparatus of claim 2, where the sensors each comprise:
a sensor layer; and
a protective coating layer that overlays the sensor layer.

5. The apparatus of claim 4, where the sensor layer comprises:
a substrate;
conductive electrodes for receiving power and transmitting data;
a dielectric insulating layer for insulating the electrodes;
a photoconductive detector for detecting laser irradiation; and
a resistive temperature detector for measuring the surface temperature of the target.

6. The apparatus of claim 5, where the photoconductive detector comprises lead sulfide quantum dots.

7. The apparatus of claim 5, where the photoconductive detector achieves at least 1 cm resolution of the laser irradiation.

8. The apparatus of claim 5, where the photoconductive detector measures laser wavelengths in the range of 1.0-2.0 μm.

9. The apparatus of claim 5, where the photoconductive detector has less than 5% interaction with the laser irradiation.

10. The apparatus of claim 5, where the resistive temperature detector can measure temperatures up to 600° C.

11. The apparatus of claim 4, where the protective coating layer comprises a metal layer that is 2 microns in thickness.

12. The apparatus of claim 11, where the protective coating layer has an aperture that is 150 microns in diameter that allows the laser irradiation to reach the sensor layer.

13. The apparatus of claim 4, where the protective coating layer comprises multiple metal layers that are each 2 microns in thickness.

14. The apparatus of claim 2, where data retrieved from the sensor is stored onboard the target for later retrieval.

15. The apparatus of claim 2, where data retrieved from the sensor is transmitted to a receiving station in real time.

16. An apparatus for measuring laser irradiance and thermal response on a target, comprising:
means for detecting laser irradiation on the skin of the target with a photoconductive detector;
means for measuring the surface temperature of the target with a resistive temperature detector; and
means for collecting and transmitting data concerning the laser irradiation and surface temperature to a receiving station.
